(19) United States
(12) Patent Application Publication
(10) Pub. No.: US 2026/0266138 A1
(43) Pub. Date: Sep. 10, 2026

(54) EARTH CUTTING APPARATUS NOZZLES AND RELATED METHODS

(71) Applicant: Kennametal Inc., Latrobe, PA (US)

(72) Inventors: Michael J. Orange, Latrobe, PA (US); Ronald S. Moore, Latrobe, PA (US)

(73) Assignee: Kennametal Inc., Latrobe, PA (US)

(21) Appl. No.: 19/354,350

(22) Filed: Oct. 9, 2025

Related U.S. Application Data
(60) Provisional application No. 63/758,474, filed on Feb. 14, 2025.

(51) Int. Cl. E21B 7/18

(52) U.S. Cl. CPC E21B 7/18

(57) ABSTRACT

A cutting apparatus for cutting earth can utilize a plurality of nozzles. Each nozzle can include a plurality of curved passageways defined in the body of the nozzle to direct fluid through the nozzle for being ejected from outlets of the nozzle so the fluid can contact debris being cut by a cutting member to help direct that debris away from the cutting member, help minimize dust formation during cutting operations, and/or help cool the cutting member. In some embodiments, the fluid that can be output from outlets of the nozzle can be a liquid that can experience reduced friction as it passes through the nozzle to provide a fluid flow that is more efficiently passable through the nozzle and/or able to pass through the nozzle so the output fluid can be output at higher velocities.

### CROSS-REFERENCE TO RELATED APPLICATIONS

The present application claims priority to U.S. Provisional Patent Application No. 63/758,474, which was filed on Feb. 14, 2025.

### FIELD OF THE INVENTION

The present invention relates to an earth cutting tool that can be utilized in conjunction with drilling, cutting of earth, and/or cutting of material, nozzles configured for use in conjunction with such machines, and methods for making and using the nozzles and/or earth cutting tool.

### BACKGROUND OF THE INVENTION

Examples of cutting tools that can be configured to cut into earth, dirt, rock, or minerals can be found in U.S. Pat. Nos. 3,841,707, 3,865,437, 4,084,856, 5,607,206, 6,244,665, 6,478,383, 8,322,465 and 10,662,716. Some types of cutting tools can be utilized to manipulate earth or other material for excavation work, drilling, or for mining applications, for example.

### SUMMARY OF THE INVENTION

In some types of cutting applications, it can be desired to facilitate drilling or mining via a moveable cutting member that can include one or more flutes. The cutting member having the flutes can be rotated to facilitate cutting of earth or mineral, for example. The flutes can help guide motion of cut material (e.g. cut earth, debris, etc.) away from the material being cut and/or can help facilitate cutting as well. Each cutting tool can also be configured to distribute a liquid (e.g. spray of water, spray of other liquid, etc.) adjacent the cutting tool. The liquid can be output to wet the cut material to reduce dust formation, cool at least a portion of the cutting member of the cutting tool, and/or help facilitate a flow of the cut material away from the cutting member of the cutting tool.

We have found that a nozzle can be provided for inclusion in a moveable cutting member (e.g. a rotational cutting member that may also be vertically moveable) to facilitate the output of fluid (e.g. a liquid) from the nozzle to help cool the cutting member and/or guide debris away from the cutting member as the cutting member is moved to cut material (e.g. drill into earth to remove dirt, rock, or stone, cut into minerals or rock, etc.). Embodiments of the nozzle can be provided so that flow paths (e.g. passageways) for fluid passed through the nozzles can follow curved flow path conduits having smooth or substantially smooth conduit walls so that the fluid can be passed through the nozzle and experience reduced friction so that the fluid can be passed through the nozzle more efficiently and/or at a higher velocity. In some embodiments, nozzles can be positioned adjacent to or behind flutes of the cutting member.

Embodiments of the nozzle can be formed via an additive manufacturing process (e.g. binder jet processing, etc.) to form the body of the nozzle having the fluid flow passageways defined within the body. The passageways for different outlets can be spaced apart from each other within a body of the nozzle and can each have curved segments for guiding fluid from a fluid intake chamber of the nozzle to the outlets of the nozzle. Each fluid flow passageway can extend from a fluid intake chamber defined in the body of the nozzle to a respective outlet of a plurality of outlets of the nozzle or to a plurality of outlets of the nozzle.

In some embodiments, the body of the nozzle having the fluid flow passageways can be formed via an additive manufacturing process to define the passageways, outlets, and fluid intake chamber of the nozzle within the body of the nozzle. The outlets of the nozzle can be on a distal end or outer end of the nozzle and the fluid intake chamber can be on an opposite end of the nozzle (e.g. inner end, or end that is positionable adjacent to the cutting member).

The body of the nozzle can be formed from a metal material, ceramic material, composite material, an alloy material, or other suitable material. In some embodiments, each nozzle can be formed from a carbide material, steel, tungsten carbide material, cemented tungsten carbide material, or other suitable type of material.

In a first aspect, a cutting apparatus is provided. Embodiments of the cutting apparatus can include a plurality of nozzles connectable to an earth cutting member that is moveable (e.g. plungeable and/or rotational, etc.) to cut into ground. Embodiments can utilize a cutting member that can be configured for drilling or mining, for example. Each of the nozzles can have a body defining a fluid intake chamber adjacent a first end of the body, a plurality of outlets defined in a second end of the body that is opposite the first end of the body, and a plurality of fluid flow passageways extending from the fluid intake chamber to the outlets such that each of the fluid flow passageways extends from the fluid intake chamber to a respective one of the outlets. The fluid intake chamber can have a mouth defined at the first end of the body. The body can be defined such that at least one of the fluid flow passageways has an intermediate segment that has a curve or bend that extends about a pre-selected angle of curvature. The intermediate segment can be located between the fluid intake chamber and the outlet to which the fluid flow passageway extends.

In some embodiments, the body can be formed via an additive manufacturing process. The body can be formed from a metal, a combination of metals, a ceramic material, a carbide material, steel, an alloy, a composite, or another suitable type of material.

In a second aspect, the fluid flow passageways can include a first fluid flow passageway and a second fluid flow passageway and the outlets can include a first outlet and a second outlet. The first fluid flow passageway can extend from the fluid intake chamber to the first outlet and the second fluid flow passageway can extend from the fluid intake chamber to the second outlet. The first fluid flow passageway can have the intermediate segment having the curve or bend that extends about the pre-selected angle of curvature. In some embodiments, the second fluid flow passageway can also have the intermediate segment having the curve or bend that extends about the pre-selected angle of curvature.

In some embodiments, the fluid flow passageways can also include a third fluid flow passageway and the outlets can also include a third outlet. The third fluid flow passageway can extend from the fluid intake chamber to the third outlet. In some embodiments, the third fluid flow passageway can have the intermediate segment having the curve or bend that extends about the pre-selected angle of curvature positioned between the fluid intake chamber and the third outlet.

In a third aspect, the pre-selected angle of curvature is between 60° and 120°. For example, the pre-selected angle of curvature can be between 60° and 100°, 70° and 110°, 80° and 100°, 75° and 110°, or other suitable angle of curvature. The pre-selected angle of curvature can be selected to account for the length of the fluid flow passageways to be defined in the body, the width or diameter of the body, the width or diameter of the fluid flow passageways, the number of fluid flow passageways to be included, and the number of outlets to be included.

In a fourth aspect, each of the fluid flow passageways has a length and the intermediate segment that has the curve or bend that extends about the pre-selected angle of curvature is positioned so that an apex of the curve or bend is located at a distance from an interface of the fluid intake chamber that is between 40% and 60% of the length. The interface of the fluid intake chamber can be an inner portion of the fluid intake chamber at which the fluid flow passageways are fluidly connected to the fluid intake chamber.

In a fifth aspect, the outlets can be positioned so that a center of each outlet is an equidistant distance from centers of the other outlets. In some embodiments, the center of each of the outlets can be defined in the second end of the body so that each of the centers is positionable along a pre-defined circle or ring of the second end of the nozzle that is smaller in diameter a width or diameter of the second end of the body.

In a sixth aspect, there can be at least three fluid flow passageways defined in the body and the fluid flow passageways can each have a centerline. The centerline can pass through a center of the passageway as the passageway extends from the fluid intake chamber to the outlet to which the fluid flow passageway is connected. The centerline of each of the fluid flow passageways can be a distance of between 0.635 cm and 1.27 cm from the centerlines of the other fluid flow passageways.

In a seventh aspect, the cutting apparatus of the first aspect can include one or more features of the second aspect, third aspect, fourth aspect, fifth aspect and/or sixth aspect. Embodiments can also include other features or elements. Examples of such other features or elements can be appreciated from the exemplary embodiments discussed herein.

In an eighth aspect, a nozzle for an earth cutting apparatus is provided. The nozzle can include a body defining a fluid intake chamber adjacent a first end of the body, a plurality of outlets defined in a second end of the body that is opposite the first end of the body, and a plurality of fluid flow passageways extending from the fluid intake chamber to the outlets such that each of the fluid flow passageways extends from the fluid intake chamber to a respective one of the outlets. The fluid intake chamber can have a mouth defined at the first end of the body. The body can be defined such that at least one of the fluid flow passageways has an intermediate segment that has a curve or bend that extends about a pre-selected angle of curvature. The intermediate segment can be located between the fluid intake chamber and the outlet to which the fluid flow passageway extends.

In some embodiments, the body of the nozzle can be formed via an additive manufacturing process. The body can be formed from a metal, a combination of metals, a ceramic material, a carbide material, steel, an alloy, a composite, or another suitable type of material.

In some embodiments, the pre-selected angle of curvature is between 60° and 120°. For example, the pre-selected angle of curvature can be between 60° and 100°, 70° and 110°, 80° and 100°, 75° and 110°, or other suitable angle of curvature. The pre-selected angle of curvature can be selected to account for the length of the fluid flow passageways to be defined in the body, the width or diameter of the body, the width or diameter of the fluid flow passageways, the number of fluid flow passageways to be included, and the number of outlets to be included.

In a ninth aspect, the fluid flow passageways can include a first fluid flow passageway and a second fluid flow passageway and the outlets can include a first outlet and a second outlet. The first fluid flow passageway can extend from the fluid intake chamber to the first outlet, the second fluid flow passageway can extend from the fluid intake chamber to the second outlet. The first fluid flow passageway can have the intermediate segment having the curve or bend that extends about the pre-selected angle of curvature. In some embodiments, the second fluid flow passageway can also have the intermediate segment having the curve or bend that extends about the pre-selected angle of curvature.

In some embodiments, a third fluid flow passageway and a third outlet can also be defined in the body. The first fluid flow passageway can extend from the fluid intake chamber to the third outlet. The third fluid flow passageway can have the intermediate segment having the curve or bend that extends about the pre-selected angle of curvature positioned between the fluid intake chamber and the third outlet.

In a tenth aspect, the outlets of the nozzle can be circular, slots, round-end slots, arced round-end slots, oval, or generally oval in shape. The fluid flow passageway can be defined so that their cross-sectional shapes match the shape of the outlet to which the passageway is connected or is the same cross-sectional shape.

In some embodiments, the outlets can be positioned so that a center of each outlet is an equidistant distance from centers of the other outlets. In some embodiments, the center of each of the outlets can be defined in the second end of the body so that each of the centers is positionable along a pre-defined circle or ring of the second end of the nozzle that is smaller in diameter a width or diameter of the second end of the body.

In an eleventh aspect, each of the fluid flow passageways has a length and the intermediate segment that has the curve or bend that extends about the pre-selected angle of curvature is positioned so that an apex of the curve or bend is located at a distance from an interface of the fluid intake chamber that is between 40% and 60% of the length. In some embodiments, the interface of the fluid intake chamber can be an inner portion of the fluid intake chamber at which the fluid flow passageways are fluidly connected to the fluid intake chamber.

In a twelfth aspect, there can be at least three fluid flow passageways defined in the body and the fluid flow passageways can each have a centerline that passes through the center of each passageway. In some embodiments, the centerline of each of the fluid flow passageways can be a distance of between 0.635 cm and 1.27 cm from the centerlines of the other fluid flow passageways.

In a thirteenth aspect, the nozzle of the eighth aspect can include one or more features of the ninth aspect, tenth aspect, eleventh aspect, and/or twelfth aspect. Embodiments can also include other features or elements. Examples of such other features or elements can be appreciated from the exemplary embodiments discussed herein.

In a fourteenth aspect, a method of making and/or using a nozzle for an earth cutting apparatus is provided. Embodiments of the method can include forming a nozzle via an additive manufacturing process. The formed nozzle can be an embodiment of the nozzle of the eighth through thirteenth aspects in some embodiments.

In some embodiments, the forming of a nozzle via the additive manufacturing process can be performed such that the nozzle has a body defining a fluid intake chamber adjacent a first end of the body, a plurality of outlets defined in a second end of the body that is opposite the first end of the body, the outlets including a first outlet and a second outlet, and a plurality of fluid flow passageways. The fluid flow passageways can include a first fluid flow passageway extending from the fluid intake chamber to the first outlet and the second fluid flow passageway extending from the fluid intake chamber to the second outlet. The fluid intake chamber can have a mouth defined at the first end of the body. The body can be defined so that the first fluid flow passageway has an intermediate segment that has a curve or bend that extends about a pre-selected angle of curvature, the intermediate segment of the first fluid flow passageway being located between the fluid intake chamber and the first outlet and/or the second fluid flow passageway has an intermediate segment that has a curve or bend that extends about a pre-selected angle of curvature, the intermediate segment of the second fluid flow passageway being located between the fluid intake chamber and the second outlet.

Embodiments of the method can also include others process steps or other elements or features. For example, the body can be formed via a 3D printing process or a binder jet process to form a nozzle of any of the eighth through thirteenth aspects. As another example, the method can also include other steps, such as connecting the nozzles to a cutting member for output of fluid, and/or movement of the cutting member to cut into the ground while fluid is output from the outlets of the nozzles.

These and other embodiments shall be described in more detail herein and in the drawings that show exemplary embodiments. Therefore, other details, objects, and advantages will become apparent as the following description of certain present preferred embodiments thereof and certain present preferred methods of practicing the same proceeds.

### BRIEF DESCRIPTION OF THE DRAWINGS

Exemplary embodiments of a cutting apparatus, a nozzle for a cutting member of a cutting apparatus, and methods of making and using the same are shown in the accompanying drawings. It should be appreciated that like reference numbers used in the drawings may identify like components.:

FIG. 1 is a schematic illustration of a first exemplary embodiment of a cutting apparatus 1 having a plurality of nozzles 9 positioned on or in a moveable cutting member 5.

FIG. 2 is a front perspective view of a first exemplary embodiment of the nozzle 9 that can be utilized in the first exemplary embodiment of the cutting apparatus 1.

FIG. 3 is a rear perspective view of a first exemplary embodiment of the nozzle 9 that can be utilized in the first exemplary embodiment of the cutting apparatus 1.

FIG. 4 is a rear perspective view of a second exemplary embodiment of the nozzle 9 that can be utilized in the first exemplary embodiment of the cutting apparatus 1.

FIG. 5 is a front perspective view of the second exemplary embodiment of the nozzle 9 that can be utilized in the first exemplary embodiment of the cutting apparatus 1.

FIG. 6 is a cross-sectional view of the second exemplary embodiment of the nozzle 9.

FIG. 7 is another perspective view of the second exemplary embodiment of the nozzle 9 with the outer surface 9s shown in phantom to better illustrate the fluid intake chamber 9c, fluid flow passageways 9fp, and outlets 9o of the nozzle 9.

FIG. 8 is another perspective view of the second exemplary embodiment of the nozzle 9 with the outer surface 9s shown in phantom to better illustrate the fluid intake chamber 9c, fluid flow passageways 9fp, and outlets 9o of the nozzle 9.

FIG. 9 is a side view of the of the second exemplary embodiment of the nozzle 9 with the outer surface 9s shown in phantom to better illustrate the fluid intake chamber 9c, fluid flow passageways 9fp, and outlets 9o of the nozzle 9.

FIG. 10 is a flow chart illustrating an exemplary embodiment of a method of making nozzles 9 for inclusion in a cutting apparatus 1 and/or using the nozzles 9 of a cutting apparatus 1.

### DESCRIPTION

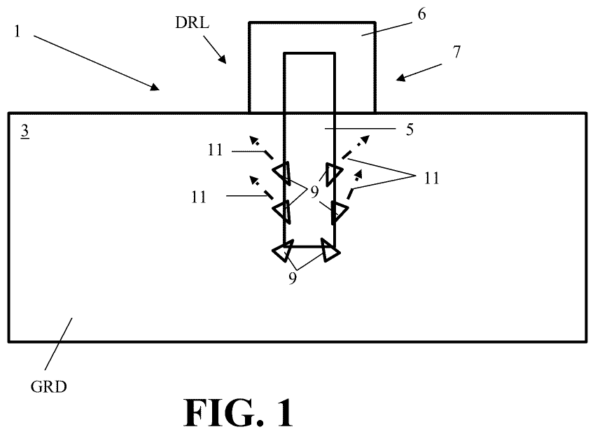

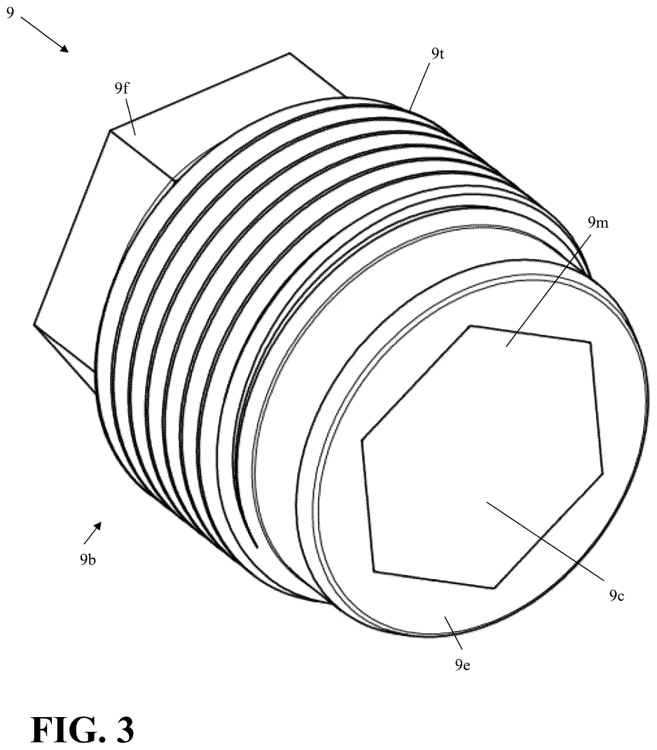

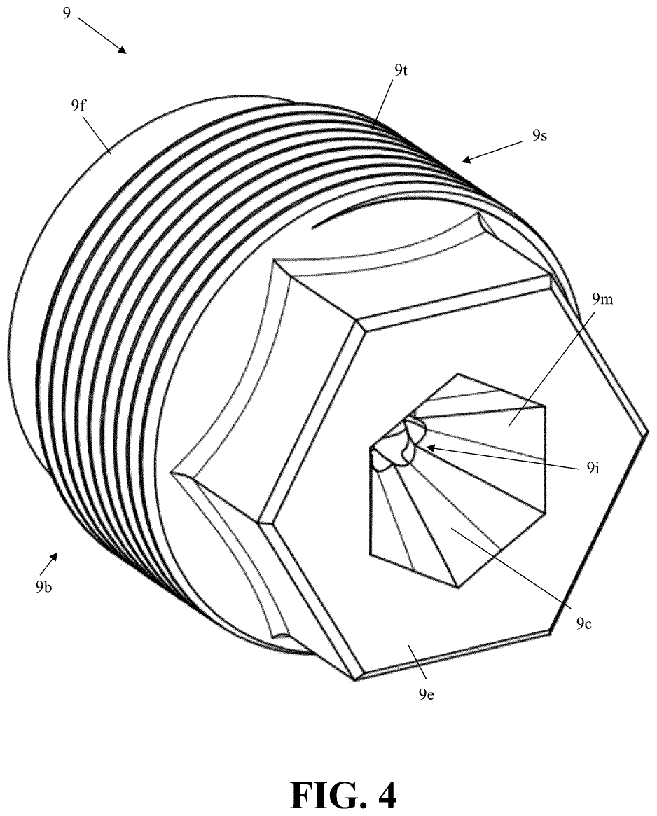

Referring to FIG. 1 through FIG. 9, a cutting apparatus 1 can be configured to cut into the earth 3. For example, the cutting apparatus 1 can include a cutting device 7 that is positionable for drilling into the ground (GRD). The cutting device 7 can be configured as a drill (DRL) that can cut into the earth 3. The material that may be cut during cutting operations can include dirt, earth, rock, sediment, shale, or other material within a portion of the ground (GRD). Embodiments can be configured for oil and/or gas drilling, mineral mining applications, or other type of earth cutting application.

The cutting device 7 can include a support 6 configured and positioned to support a moveable cutting member 5 that can be positionable adjacent to a surface of the ground and/or moved into the ground for cutting into the ground. The cutting device 7 can also include cutting member movement mechanisms and/or other elements. For example, the cutting device can include a cutting member movement mechanism that is connected to the cutting member so that the cutting member 5 can be rotated for cutting into the ground.

The rotatable cutting member 5 can include cutting elements positioned along flutes and/or a cutting end of the cutting member 5. The cutting member 5 can also have a plurality of nozzles 9 positioned along an outer surface of the body of the cutting member 5. In some embodiments, the nozzles can be positioned behind flutes and be configured to direct fluid passed through the nozzles 9 so that the fluid moves away from the cutting member 5 in a fluid output flow 11 to direct cut material away from the cutting member 5 and/or wet the cut material (e.g. debris) to help limit dust formation. The nozzles 9 can also be configured to output fluid to help cool the cutting member 5.

In some embodiments, the fluid passed to the nozzles 9 can be a liquid. For example, the fluid can include liquid water or a liquid solution that includes water as well as other elements and/or compounds. A source of the fluid (e.g. at least one reservoir, vessel, or tank) can be connected to the nozzles 9 via a fluid feed conduit arrangement. A pump can be connected to the fluid feed conduit arrangement as well to help feed the fluid to the nozzles 9 at a pre-selected velocity and/or pressure.

Embodiments of the nozzle 9 can be shaped and configured to include multiple outlets 9o defined in the body 9b of the nozzle 9 so that the fluid is passable through the body 9b of the nozzle 9 and out of the outlets 9o in a fluid output flow 11 to direct cut material away from the cutting member 5, wet the cut material (e.g. debris) to help limit dust formation, and/or facilitate cooling of the cutting member 5.

The body 9b of each nozzle 9 can include a first end 9e and a second end 9f that is opposite the first end 9e. The second end 9f can be a distal end of the body 9b of the nozzle 9 in some embodiments. The first end 9e can be a considered an inner end that can be positioned adjacent to the cutting member 5 (e.g. in or on the cutting member 5) so that the nozzle can be coupled to the cutting member 5.

The body 9b of the nozzle 9 can also have an outer surface 9s that extends from the first end 9e to the second end 9f. The outer surface 9s can have threads 9t defined thereon to help facilitate attachment of the nozzle to a portion of the fluid feed conduit arrangement and/or cutting member 5 so that fluid is passable into a fluid intake chamber 9c defined in the first end 9e of the body 9b. The fluid intake chamber 9c can be defined to include a mouth 9m adjacent the first end so that fluid can be passed into the body 9b of the nozzle 9 and into the fluid intake chamber 9c for being guided to the outlets 9o via different fluid flow passageways 9fp defined in the body 9b. In some embodiments, the mouth 9m can be relatively straight. In other embodiments, the mouth 9m may be tapered so that the mouth narrows as it extends from the first end 9e into the body to the main cavity of the fluid intake chamber 9c.

Each fluid flow passageway 9fp can extend from the fluid intake chamber 9c to a respective outlet 9o within the body 9b (e.g. within the outer surface 9s of the body 9b). Each fluid flow passageway 9fp can include at least one curved segment and can be defined so that the inner wall(s) of the body 9b that define the fluid flow passageway 9fp are smooth or substantially smooth (e.g. essentially smooth, induce low friction due to the inner surface of the wall(s) that define the fluid flow passageway 9fp inside the body 9b, etc.). Each fluid flow passageway 9fp can be shaped and configured to define a flow path FP for fluid passed through the passageway. This flow path can be defined for fluid passing from the first end 9e of the body to the second end 9f of the body such that the fluid changes directions as it moves toward the second end 9f. The change of directions can include the fluid path moving along a curve or bend having an apex 9ap defined in the passageway 9fp, for example. The change of directions can result in lateral and/or vertical changes of direction while the fluid flows from the first end 9e to the second end 9f. These changes of direction can be directions that are transverse to an axis of the nozzle that may be defined by the length of the nozzle that extends from the first end 9e to the second end 9f (e.g. vertical change of direction can be transverse to the axis of the nozzle 9 that may extend from the first end 9e to the second end 9f and the lateral change of direction can also be transverse to the axis of the nozzle 9 that may extend from the first end 9e to the second end 9f.

The fluid intake chamber 9c and the fluid flow passageways 9fp can be positioned within the body 9b so that there is an interface 9i defined between the fluid intake chamber 9c and the different fluid flow passageways 9fp. The interface 9i can be positioned within the body 9b and be positioned closer to the second end 9f as compared to the mouth 9m. The interface 9i can be at an innermost portion of the fluid intake chamber 9c in some embodiments while the mouth 9m can be at an outermost portion of the fluid intake chamber 9c adjacent to or at the first end 9e of the body 9b.

The interface 9i of the fluid intake chamber 9c can be an inner portion of the fluid intake chamber 9c at which the fluid flow passageways 9fp are fluidly connected to the fluid intake chamber 9c. The interface 9i can have a common inlet that is fluidly connected to the different fluid flow passageways 9fp for passing fluid to those fluid flow passageways 9fp (e.g. all of the fluid flow passageways or at least some of the fluid flow passageways can be in fluid communication with a common inlet of the interface 9i for fluid to be passed into each fluid flow passageway 9fp). The interface 9i can also be configured so that it is defined in fluid communication with different inlets for the different fluid flow passageways 9fp (e.g. each fluid flow passageway can have an inner end having its own respective inlet in fluid communication with the interface 9i of the fluid intake chamber 9c). Each inlet at the interface 9i can have a smaller width or diameters so that fluid passed through the inlet and into the fluid flow passageways 9fp can have an increased velocity as the fluid enters into the passageways and is passed therethrough.

Fluid (e.g. a liquid, a slurry, an aqueous solution, etc.) can be passable through the interface 9i for being diverted into the different fluid flow passageways 9fp for being routed to different outlets 9o to form the fluid output flow 11. The fluid can be passable from the interface 9i to the different fluid flow passageways 9fp so that each outlet 9o of the nozzle body 9b can direct a jet of fluid out of the nozzle as part of the fluid output flow 11 emitted from the nozzle.

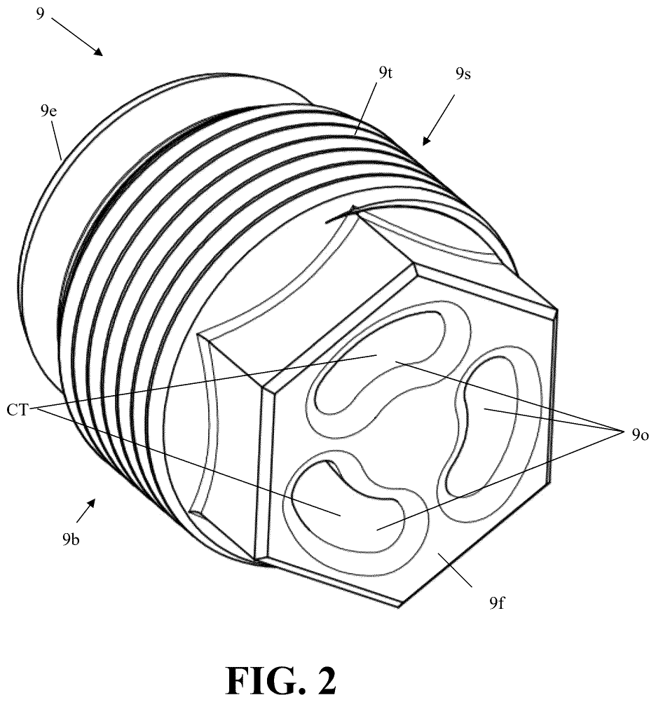

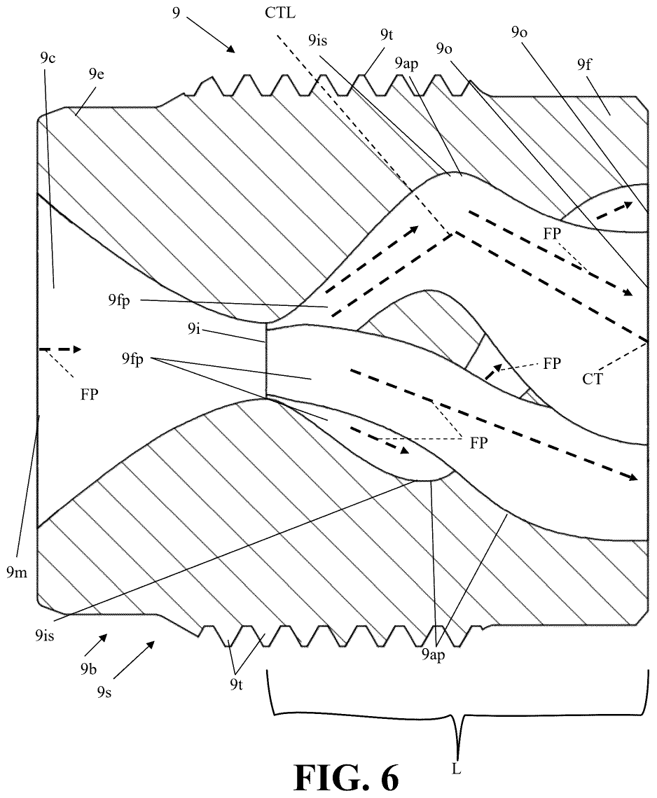

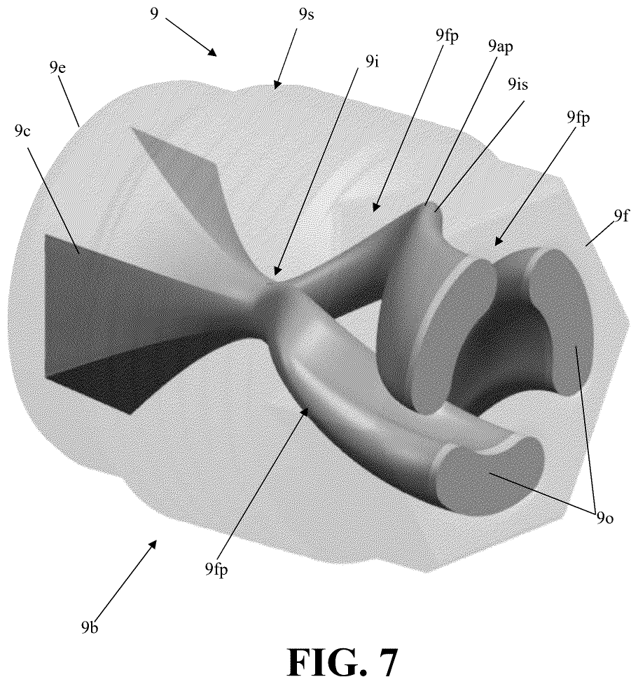

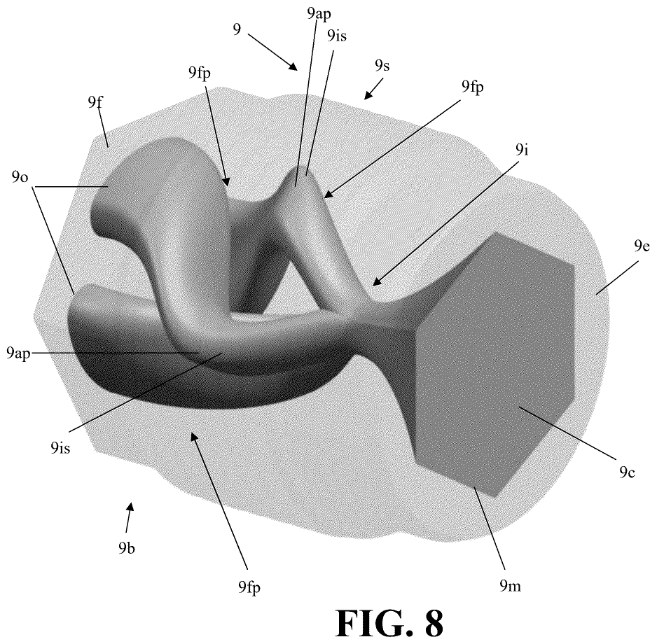

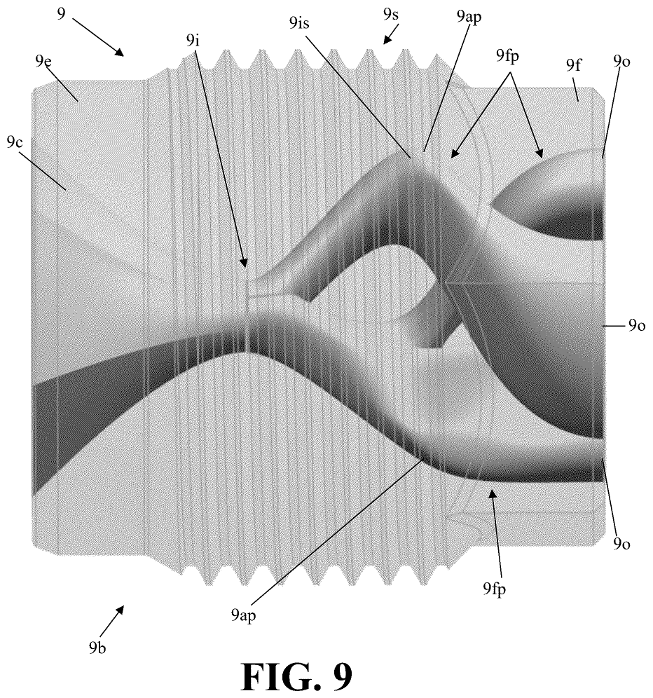

As may best be appreciated from FIG. 6, FIG. 7, FIG. 8, and FIG. 9, each fluid flow passageway 9fp can extend along its length L from the common interface 9i of the fluid intake chamber 9c to a respective outlet 9o. The exemplary embodiments illustrated in the FIG. 2 through FIG. 9 illustrate three outlets 9o. Other embodiments may utilize only two outlets 9o or may utilize more than three outlets 9o. The size and configuration of the fluid flow passageways 9fp and outlets 9o can be adapted for a particular set of design criteria. Likewise, the size of the fluid intake chamber 9c and mouth 9m can be adapted for a particular set of design criteria so a sufficient amount of fluid is feedable into the nozzle 9 for being emitted from the outlets 9o to form a desired fluid output flow 11 having a desired pre-selected output pressure and/or velocity.

Each fluid flow passageway 9fp can include one or more curved segments. The curved segments can be portions of a single continuous conduit defined in the body 9b to extend from the interface 9i of the fluid intake chamber 9c and a respective outlet 9o. The inner wall of each fluid flow passageway 9fp can be smooth to help reduce friction experienced by the fluid as it is passed through the fluid flow passageway toward the outlet 9o. In some embodiments a diameter or width of each fluid flow passageway 9fp can be uniform or relatively uniform. In some embodiments, the diameter or width of each fluid flow passageway 9fp can be between 0.0625 inches (0.159 cm) and 0.25 inches (0.635 cm) for a nozzle body 9b that is sized and configured to have an overall length of between 0.5 inches to 1.5 inches, or 1.27 cm to 3.81 cm.

In other embodiments, the diameter or width of each fluid flow passageway may change as the fluid flow passageway extends from the interface 9i to the outlet 9o. In such embodiments, the portion of the fluid flow passageway at the interface 9i can be a narrowest portion of the fluid flow passageway 9fp and the portion of the fluid flow passageway adjacent to the outlet 9o can be the widest portion (or portion with the largest diameter) of the fluid flow passageway 9fp. The diameter or width of the fluid flow passageway 9fp can continuously increase as the fluid flow passageway extends from the interface 9i to the outlet 9o in some embodiments. In other embodiments, different segments of the fluid flow passageway can have different diameters or width as the fluid flow passageway 9fp extends from the interface 9i to the outlet 9o.

The fluid flow passageways 9fp defined in the body 9b can also be spaced apart from each other. For example, each fluid flow passageway 9fp can be between 0.1 inches (0.254 cm) and 0.35 inches (0.889 cm) cm away from each other for a nozzle body 9b having a width or diameter of between 0. 5 inches to 1.5 inches (1.27 cm to 3.81 cm). In such embodiments, each fluid flow passageway may be equidistantly spaced away from each other for feeding fluid from the interface 9i to the outlets 9o, which may also be equidistantly spaced apart from each other at the second end 9f of the body 9b. The spacing between passageways 9fp can depend upon the number of passageways, the diameter or width of the passageways 9fp, and the diameter or width of the nozzle body 9b. Narrower passageways can be spaced further apart from each other as compared to wider passageways so that the passageways 9fp can be defined within the body 9b without breaking through the outer surface 9s of the body 9b.

In some embodiments, each fluid flow passageway 9fp can include at least one bend or elbow that curves at an angle of curvature of between 60° and 120°(e.g. between 65° and 115°, between 75° and 110°, between 80° and 100°, etc.). For example, each fluid flow passageway 9fp can include an intermediate segment 9is positioned between the interface 9i and the outlet 9o that can have an angle of curvature of between 60° and 120°. Some embodiments can be configured so that each fluid flow passageway 9fp has multiple different elbows or bends. Other embodiments can be configured so that the body 9b defines each fluid flow passageway 9fp to include a single bend or elbow at an intermediate segment 9is wherein the intermediate segment 9is can be located near or at a middle of the length L of the fluid flow passageway (e.g. a location along the length L of the fluid flow passageway that is at a distance from the interface 9i equal to 30%-70% of the length L of the fluid flow passageway, a location along the length L of the fluid flow passageway 9fp that is at a distance from the interface 9i that is equal to 40%-60% of the length L of the fluid flow passageway or a location along the length L of the fluid flow passageway that is at a distance from the interface 9i that is equal to 50% of the length L of the fluid flow passageway).

For example, the apex 9ap of the bend or curve of the intermediate segment 9is can be located at a position along the length L of the fluid flow passageway that is a distance along the length L of the fluid flow passageway 9fp that is 40% to 60% of the length L (e.g. in an embodiment where the length L of the fluid flow passageway 9fp may be 1 cm, the apex 9ap of the intermediate segment's curve or bend can be located at a distance of 0.4-0.6 cm from the interface 9i along the length L of the fluid flow passageway or the apex 9ap of the intermediate segment's curve or bend can be located at a distance of 0.5 cm from the interface 9i along the length L of the fluid flow passageway) in some embodiments. In other embodiments, the apex 9ap of the bend or curve of the intermediate segment can be located at a position along the length L of the fluid flow passageway that is a distance along the length L of the fluid flow passageway 9fp that is 30% to 70% of the length L or is 45%-55% of the length L. In yet other embodiments, the apex 9ap of the bend or curve of the intermediate segment can be located at a position along the length L of the fluid flow passageway that is a distance along the length L of the fluid flow passageway 9fp that is 50% of the length L.

In some embodiments, each fluid flow passageway 9fp for each outlet 9o can have a curve or bend at and intermediate segment that is located at different distances along the length L of the fluid flow passageways. For example, the apex 9ap of the curve or bend of the intermediate segment 9is can be at a position along the length L of the fluid flow passageway that is 40% or 60% of the length L for a first fluid flow passageway 9fp, the apex 9ap of the curve or bend of the intermediate segment 9is can be at a position along the length L of the fluid flow passageway that is 50% of the length L for a second fluid flow passageway 9fp, and the apex 9ap of the curve or bend of the intermediate segment 9is can be at a position along the length L of the fluid flow passageway that is 45% or 55% of the length L for a third fluid flow passageway 9fp. In yet other embodiments, the apex 9ap of the curve or bend of the intermediate segment 9is for at least some of the fluid flow passageways or all of the fluid flow passageways may be at similar distance along the length L of the fluid flow passageway (e.g. each of the intermediate segments for each fluid flow passageway can be located at a position along the length L of the fluid flow passageways that is 50% of the length L of the fluid flow passageways, or at least some of the intermediate segments of some of the fluid flow passageways 9fp can be at a position along the length L of the fluid flow passageways that is 50% of the length L of the fluid flow passageways while at least one other fluid flow passageway may have an intermediate segment 9is having an apex 9ap of a curve or bend at another distance along the length L of that fluid flow passageway, etc.).

Each fluid flow passageway can have a cross-sectional shape. The cross-sectional shape of the fluid flow passageway may be uniform or vary as the fluid flow passageway 9fp extends from the interface 9i to the outlet 9o. In some embodiments, the cross-sectional shape may be slot-like in shape, circular, oval, generally oval in shape, or have other type of suitable shape. The outlets 9o can be slots, circular slots, generally oval shaped slots, round-end slots, arced round-end slots circular, oval, generally oval in shape, or have other type of suitable shape and the cross-sectional shape of the fluid flow passageway 9fp can be the same as the shape of the outlet 9o or be similar in shape to the shape of the outlet 9o.

Each fluid flow passageway 9fp can be defined so that it has a centerline CTL that extends along the center of the fluid flow passageway as the fluid flow passageway extends along its length from the interface 9i to the outlet 9o. The centerline can extend along a center of the fluid flow passageway (e.g. at an innermost, central location of the fluid flow passageway 9fp as it extends from the interface 9i to the outlet 9o). Each outlet can have a center CT that is a terminal end of the centerline CTL at the outlet 9o. The center CT of the outlet 9o can be at a central position of the outlet (e.g. at an innermost, central location of the outlet 9o). The fluid flow passageways 9fp can be defined so that the centerline CTL of each fluid flow passageway 9fp is spaced between 0.25 inches (0.635 cm) and 0.5 inches (1.27 cm) away from the other centerlines CTL of the other fluid flow passageways 9fp defined in the body 9b of the nozzle 9. For example, the fluid flow passageways 9fp can be positioned so that the apex 9ap of each intermediate segment of each fluid flow passageway is between 0.35 inches (0.889 cm) and 0.6 inches (1.524 cm) from the other apexes 9ap of the bend or curve of the other intermediate segments 9is of the other fluid flow passageways.

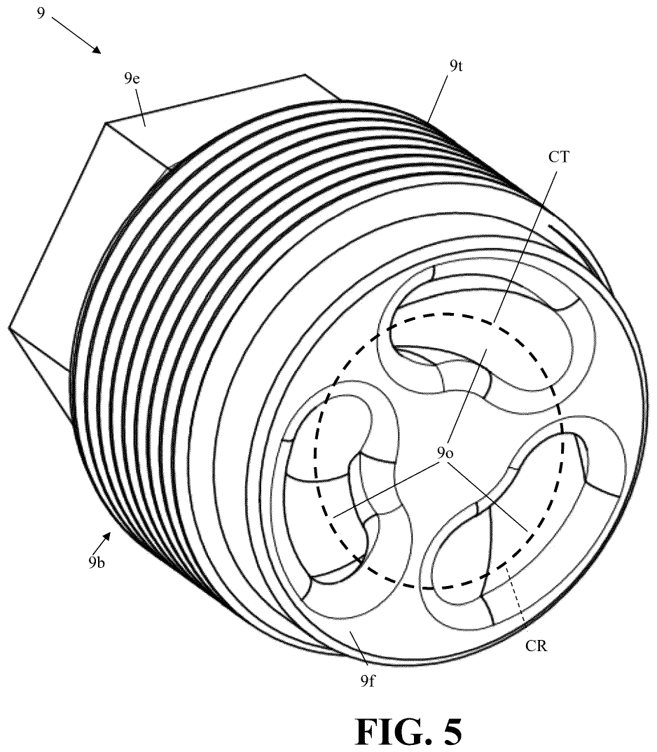

In some embodiments, each outlet 9o can be defined in the second end 9f of the body so that the center CT of each outlet is an equidistant distance away from the centers CT of the other outlets. Such equidistance spacing of the outlets 9o can permit the nozzle 9 to emit jets of fluid from the outlets 9o so that the formed fluid output flow 11 is directed in a pre-selected direction and the nozzle can experience wear associated with such use in a uniform fashion. In some embodiments, the center CT of each outlet 9o can be positioned on the same circle or ring (CR) having a pre-defined diameter within an end of the nozzle 9. For instance, the centers CT of the outlets 9o can all be positioned on a pre-defined circle (CR) of a second end 9f of the nozzle (an example of which is shown in broken line in FIG. 5) and is smaller in diameter than a width or diameter of the second end 9f.

The body 9b of the nozzle can be formed via an additive manufacturing process. For example, the body 9b can be formed via a 3D printing process or a binder jet process (e.g. a 3D printing process that can utilize a liquid adhesive to bind layers of powder together to form the body 9b). The body 9b can be formed to define the fluid intake chamber 9c, fluid flow passageways 9fp, and outlets 9o as the body 9b is formed via the 3D printing process or binder jet process. The body 9b can be formed so that it has a pre-selected shape with the outer surface 9s and threads 9t and has the mouth 9m of the fluid intake chamber 9c defined in the first end 9e of the body 9b as well. In some embodiments, the body 9b can be comprised of a carbide material, steel, a tungsten carbide material, a cemented tungsten carbide material, a cubic boron nitride (CBN) material, a ceramic material, a metal, an alloy, a composite material, or other suitable type of material.

The body 9b can be formed so that fluid is passable through the fluid flow passageways 9fp while experiencing low friction via smooth inner walls of the fluid flow passageways 9fp and/or the curve or bend of the fluid flow passageways 9fp. This can facilitate outputting of fluid at higher velocities and/or feeding fluid to the nozzles at an improved efficiency (e.g. due to the decrease in friction that can act on the fluid as the fluid is passed through the fluid flow passageways 9fp).

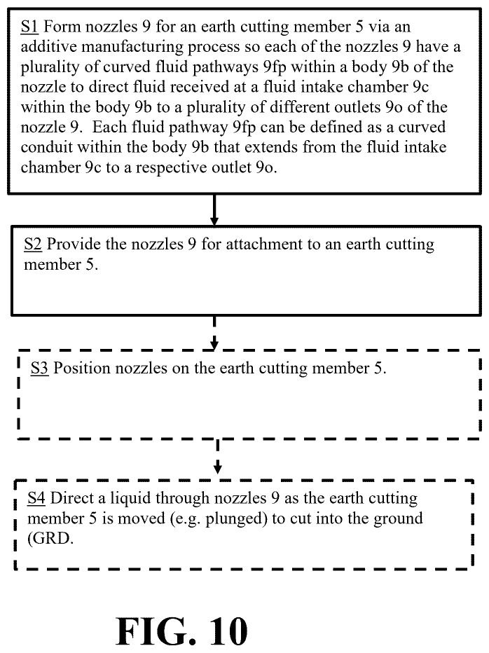

Referring to FIG. 10, an exemplary embodiment of a method for making nozzles 9 and/or using the cutting apparatus 1 is illustrated. In a first step S1, nozzles 9 can be formed for an earth cutting member 5. For example, the formed nozzles 9 can be formed for attachment to an earth cutting member 5 so that the nozzles 9 can emit a fluid in a fluid output flow 11 as discussed above. The nozzle 9 can be formed via an additive manufacturing process (e.g. 3D printing, binder jet processing, etc.) so each of the nozzles 9 have outlets 9o, a fluid intake chamber 9c, and fluid flow passageways 9fp defined within the body 9b as discussed above. For example, the formed nozzles 9 can have a plurality of curved fluid flow passageways 9fp that include a curve or bend at an intermediate segment 9is located between an interface 9i and an outlet 9o to direct fluid received at a fluid intake chamber 9c to emit a jet of the fluid from the outlet 9o. For instance, each fluid passageway 9fp can be defined as a curved conduit within the body 9b that extends from the fluid intake chamber 9c at an interface 9i to a respective outlet 9o. Each formed fluid flow passageway 9fp can have an apex of a curve or bend of the curved conduit located at an intermediate segment 9is of the fluid flow passageway 9fp as discussed above, for example.

In a second step S2, the nozzles 9 can be provided for attachment to the earth cutting member 5. For example, the nozzles 9 can be shipped to an assembly site so that the nozzles 9 can be coupled to the earth cutting member 5.

In some embodiments, the method can also include steps associated with use of the nozzles 9. For example, the nozzles 9 can be positioned on the earth cutting member 5 in a third step S3. The positioning of the nozzles 9 can be provided to facilitate improved liquid spraying during operation of the cutting apparatus 1.

As another example, liquid can be directed through the nozzles 9 as the earth cutting member 5 is moved to cut into the ground (GRD). The earth cutting member 5 can be rotated as well as adjusted in vertical position during such motion. The liquid output from the nozzles 9 can be fluid output flows 11. The fluid output flows 11 can be passed out of the nozzles 9 to direct cut material away from the cutting member 5, wet the cut material (e.g. debris) to help limit dust formation, and/or facilitate cooling of the cutting member 5. Some nozzles 9 can be positioned to emit fluid output flows that move debris away from the end of the cutting member that is deepest into the ground (GRD) while other nozzles 9 can be positioned to direct fluid output flows 11 in other directions (e.g. away from the cutting member 5, but in another direction, laterally or into the ground, etc.).

Embodiments of the method can also include other steps. For instance, operatively connecting a pump to a fluid conduit arrangement and/or a source of liquid for feeding the fluid to the nozzles 9 can be performed.

As can be appreciated from the above, some embodiments of the cutting apparatus 1 can include a plurality of nozzles 9 connectable to an earth cutting member 5 that is moveable to cut into ground (GRD). Each of the nozzles 9 can have a body 9b defining a fluid intake chamber 9c adjacent a first end 9e of the body 9b, a plurality of outlets 9o defined in a second end 9f of the body 9b that is opposite the first end 9e of the body 9b, and a plurality of fluid flow passageways 9fp extending from the fluid intake chamber 9c to the outlets 9o such that each of the fluid flow passageways 9fp extends from the fluid intake chamber 9c to a respective one of the outlets 9o. The fluid intake chamber 9c can also have a mouth 9m defined at the first end 9e of the body 9b. The body 9b can be defined such that at least one of the fluid flow passageways 9fp has an intermediate segment 9is that has a curve or bend that extends about a pre-selected angle of curvature. The intermediate segment 9is can be located between the fluid intake chamber 9c and the outlet 9o to which the fluid flow passageway 9fp extends.

In some embodiments, a nozzle 9 can be formed via an additive manufacturing process (e.g. 3D printing, binder jet printing, etc.) such that the nozzle 9 has a body 9b defining a fluid intake chamber 9c adjacent a first end 9e of the body 9b, and a plurality of outlets 9o defined in a second end 9f of the body 9b that is opposite the first end 9e of the body. The outlets 9o can include a first outlet 9o and a second outlet 9o. The body 9b can also define a plurality of fluid flow passageways 9fp. The fluid flow passageways 9fp can include a first fluid flow passageway 9fp extending from the fluid intake chamber 9c to the first outlet 9o and a second fluid flow passageway 9fp extending from the fluid intake chamber 9c to the second outlet 9o. In some embodiments, the outlets 9o can include a third outlet 9o and the fluid flow passageways 9fp can also include a third fluid flow passageway 9fp extending from the fluid intake chamber 9c to the third outlet 9o.

The body 9b can be defined such that the first fluid flow passageway has an intermediate segment 9is that has a curve or bend that extends about a pre-selected angle of curvature. The intermediate segment 9is of the first fluid passageway 9fp can be located between the fluid intake chamber 9c and the first outlet 9o. The body 9b can also be defined so that the second fluid flow passageway 9fp has an intermediate segment 9is that has a curve or bend that extends about a pre-selected angle of curvature wherein the intermediate segment 9is of the second fluid passageway 9fp can be located between the fluid intake chamber 9c and the second outlet 9o. Some embodiments can also be provided so that the body 9b is defined so that the third fluid flow passageway 9fp has an intermediate segment 9is that has a curve or bend that extends about a pre-selected angle of curvature wherein the intermediate segment 9is of the third fluid flow passageway 9fp can be located between the fluid intake chamber 9c and the third outlet 9o.

In some embodiments, the fluid intake chamber 9c can have an interface 9i that is opposite the mouth 9m. The interface 9i of the fluid intake chamber 9c can be an inner portion of the fluid intake chamber 9c at which the fluid flow passageways 9fp are fluidly connected to the fluid intake chamber 9c.

In some embodiments, the outlets 9o can be positioned so that a center CT of each outlet 9o is an equidistant distance from centers CT of the other outlets 9o.

Each of the fluid flow passageways 9fp can have a centerline CTL. The centerline CTL of each of the fluid flow passageways 9fp can be a distance of between 0.25 inches (0.635 cm) and 0.5 inches (1.27 cm) from the centerlines CTL of the other fluid flow passageways 9fp in some embodiments.

In some embodiments, each of the fluid flow passageways 9fp can have a length L and the intermediate segment 9is that has the curve or bend that extends about the pre-selected angle of curvature can be positioned so that an apex of the curve or bend is located at a distance from the interface 9i of the fluid intake chamber that is between 40% and 60% of the length L. For example, the intermediate segment 9is of the first fluid flow passageway 9fp can be defined so that an apex of the curve or bend of the intermediate segment 9is of the first fluid flow passageway 9fp is located at a distance from the interface 9i of the fluid intake chamber that is between 40% and 60% of the length L. The intermediate segment 9is of the second fluid flow passageway 9fp can also be defined so that an apex of the curve or bend of the intermediate segment 9is of the second fluid flow passageway 9fp is located at a distance from the interface 9i of the fluid intake chamber 9c that is between 40% and 60% of the length L. The intermediate segment 9is of the third fluid flow passageway 9fp can also be defined so that an apex of the curve or bend of the intermediate segment 9is of the third fluid flow passageway 9fp is located at a distance from the interface 9i of the fluid intake chamber 9c that is between 40% and 60% of the length L.

Embodiments of the nozzle 9 can be formed to have a body 9b that includes multiple fluid flow passageways 9fp. Each fluid flow passageway can be helical or spiral in shape or configuration as it extends along its length L from the fluid intake chamber 9c to the outlet 9o to which it extends. For designing the fluid flow passageways 9fp, a fit curve can be utilized to define a first fluid flow passageway 9fp and other passageways can be defined by being rotationally patterned at different spacings (e.g. 120° spacing, 90° spacing, 60° spacing, 100°spacing, 110° spacing, 60°-120° spacing, etc.) to account for the number of outlets 9o the nozzle 9 is to have and the size and configuration of the nozzle body 9b.

To create a fit curve for designing a fluid flow passageway 9fp within a body 9b, a series of planes that are parallel to the end faces of the nozzle body 9b can be defined (e.g. faces at the first end 9e and second end 9f). These different planes can be spaced at specific distances ranging from 0.125 inches (0.318 cm) to 0.375 inches (0.953 cm) apart from one another in some embodiments, for example. Each plane can be defined so that the plane has a point that is constrained in space with an x and y dimension (e.g. width and length directions) from a nozzle body centerline. A curve can then be fit through these points. This curve may not be planar and can be free form through all three axes of space (e.g. length direction, width direction, and radial direction that can be perpendicular to the length and width directions). The distances that can be selected for spacing between apexes 9ap, centerlines CTLL, centers CT of outlets 9o, and/or other spacing between the fluid flow passageways 9fp can depend on the geometry and size of the passageways, size, and shape of the body 9bs, and number of outlets 9o. The designed spiral or helical shaped fluid flow passageways 9fp can be fit to the sizing of the body 9b and be utilized for defining the body 9b to be formed via an additive manufacturing process (e.g. 3D printing, binder jet processing, etc.)

Embodiments can be utilized or configured so that liquid or other fluid passed through the body 9b of the nozzle can experience less friction and be routed more efficiently through the nozzle 9. Embodiments can permit a more efficient operation of the nozzle(s) 9 and/or permit the velocity of the fluid output from the nozzle(s) 9 to be increased.

Embodiments can also permit more design flexibility for nozzles 9 so that different types of outlets 9o and fluid flow passageway 9fp arrangements can be utilized for different cutting members 5 having different sizes, shapes, and/or different design objectives. The curved fluid flow passageways 9fp can provide reduced flow resistance to the fluid and can be formed via an additive manufacturing process so that drilling or machining for formation of fluid flow passageways or outlets can be minimized or avoided. The avoidance or minimization of drilling or machining can also help avoid formation of sharp edges in the fluid flow passageways that can provide high resistance to fluid flow (e.g. use of electrical discharge (EDM) machining for formation of fluid flow passageways 9fp can be avoided or minimized). Such features can also provide simplified manufacturing that can provide enhanced flexibility in manufacturing operations and improved efficiency in making of nozzles 9.

In some embodiments, each nozzle 9 can be formed via additive manufacturing to form the bodies 9b of the nozzle 9 with the different fluid flow passageways 9fp and fluid intake chamber 9c and outlets 9o as well as any other related internal conduits and/or orifices defined on an outer surface 9s of the body 9b without use of any type of machining (e.g. use of EDM machining such as wire or plunge EDM). For example, an additive manufacturing process can be utilized for defining the fluid flow passageways 9fp without use of drilling and/or without use of EDM.

It should be appreciated that the exemplary embodiments discussed herein can be adjusted to account for a particular set of design criteria. For example, the size and shape of the cutting member 5, the size and shape of nozzles 9, the size and shape of the fluid flow passageways 9fp, and the type of materials utilized for the body 9b of the nozzle 9 can be any of a number of different options. For instance, the type of material used for the body 9b (e.g. carbide, cemented carbine, tungsten carbide, steel, etc.) can be any of a number of suitable material (e.g. cubic boron nitride, ceramic material, other type of hard material, etc.). As another example, the shape of the moveable cutting member 5, or other elements can be adapted to meet a particular set of design criteria. Thus, while certain present preferred embodiments of the cutting apparatus 1, nozzle 9, and embodiments of methods for making and using the same have been shown and described above, it is to be distinctly understood that the invention is not limited thereto but may be otherwise variously embodied and practiced within the scope of the following claims.

What is claimed is:

1. A cutting apparatus comprising:
a plurality of nozzles connectable to an earth cutting member that is moveable to cut into ground;
each of the nozzles having:
a body, the body defining a fluid intake chamber adjacent a first end of the body, a plurality of outlets defined in a second end of the body that is opposite the first end of the body, and a plurality of fluid flow passageways extending from the fluid intake chamber to the outlets such that each of the fluid flow passageways extends from the fluid intake chamber to a respective one of the outlets, the fluid intake chamber having a mouth defined at the first end of the body;
the body defined such that at least one of the fluid flow passageways has an intermediate segment that has a curve or bend that extends about a pre-selected angle of curvature, the intermediate segment being located between the fluid intake chamber and the outlet to which the fluid flow passageway extends.

2. The cutting apparatus of claim 1, wherein the fluid flow passageways comprise a first fluid flow passageway and a second fluid flow passageway and the outlets comprise a first outlet and a second outlet, the first fluid flow passageway extending from the fluid intake chamber to the first outlet, the second fluid flow passageway extending from the fluid intake chamber to the second outlet;
wherein the first fluid flow passageway has the intermediate segment having the curve or bend that extends about the pre-selected angle of curvature.

3. The cutting apparatus of claim 1, wherein the fluid flow passageways comprise a first fluid flow passageway and a second fluid flow passageway and the outlets comprise a first outlet and a second outlet, the first fluid flow passageway extending from the fluid intake chamber to the first outlet, the second fluid flow passageway extending from the fluid intake chamber to the second outlet;
wherein the first fluid flow passageway has the intermediate segment having the curve or bend that extends about the pre-selected angle of curvature and the second fluid flow passageway also has the intermediate segment having the curve or bend that extends about the pre-selected angle of curvature.

4. The cutting apparatus of claim 1, wherein the fluid flow passageways comprise a first fluid flow passageway, a second fluid flow passageway, and a third fluid flow passageway and the outlets comprise a first outlet, a second outlet, and a third outlet, the first fluid flow passageway extending from the fluid intake chamber to the first outlet, the second fluid flow passageway extending from the fluid intake chamber to the second outlet, and the third fluid flow passageway extending from the fluid intake chamber to the third outlet;
wherein the first fluid flow passageway has the intermediate segment having the curve or bend that extends about the pre-selected angle of curvature positioned between the fluid intake chamber and the first outlet, the second fluid flow passageway also has the intermediate segment having the curve or bend that extends about the pre-selected angle of curvature positioned between the fluid intake chamber and the second outlet, and the third fluid flow passageway has the intermediate segment having the curve or bend that extends about the pre-selected angle of curvature positioned between the fluid intake chamber and the third outlet.

5. The cutting apparatus of claim 1, wherein the pre-selected angle of curvature is between 60° and 120°.

6. The cutting apparatus of claim 1, wherein each of the fluid flow passageways has a length, and the intermediate segment that has the curve or bend that extends about the pre-selected angle of curvature is positioned so that an apex of the curve or bend is located at a distance from an interface of the fluid intake chamber that is between 40% and 60% of the length.

7. The cutting apparatus of claim 6, wherein the interface of the fluid intake chamber is an inner portion of the fluid intake chamber at which the fluid flow passageways are fluidly connected to the fluid intake chamber.

8. The cutting apparatus of claim 1, wherein the outlets are positioned so that a center of each outlet is an equidistant distance from centers of the other outlets.

9. The cutting apparatus of claim 1, wherein there are at least three fluid flow passageways and the fluid flow passageways each have a centerline, the centerline of each of the fluid flow passageways being a distance of between 0.635 cm and 1.27 cm from the centerlines of the other fluid flow passageways.

10. A nozzle for an earth cutting apparatus, the nozzle comprising:
a body, the body defining a fluid intake chamber adjacent a first end of the body, a plurality of outlets defined in a second end of the body that is opposite the first end of the body, and a plurality of fluid flow passageways extending from the fluid intake chamber to the outlets such that each of the fluid flow passageways extends from the fluid intake chamber to a respective one of the outlets, the fluid intake chamber having a mouth defined at the first end of the body;
the body defined such that at least one of the fluid flow passageways has an intermediate segment that has a curve or bend that extends about a pre-selected angle of curvature, the intermediate segment being located between the fluid intake chamber and the outlet to which the fluid flow passageway extends.

11. The nozzle of claim 10, wherein the fluid flow passageways comprise a first fluid flow passageway and a second fluid flow passageway and the outlets comprise a first outlet and a second outlet, the first fluid flow passageway extending from the fluid intake chamber to the first outlet, the second fluid flow passageway extending from the fluid intake chamber to the second outlet;
wherein the first fluid flow passageway has the intermediate segment having the curve or bend that extends about the pre-selected angle of curvature.

12. The nozzle of claim 10, wherein the fluid flow passageways comprise a first fluid flow passageway and a second fluid flow passageway and the outlets comprise a first outlet and a second outlet, the first fluid flow passageway extending from the fluid intake chamber to the first outlet, the second fluid flow passageway extending from the fluid intake chamber to the second outlet;
wherein the first fluid flow passageway has the intermediate segment having the curve or bend that extends about the pre-selected angle of curvature and the second fluid flow passageway also has the intermediate segment having the curve or bend that extends about the pre-selected angle of curvature.

13. The nozzle of claim 10, wherein the fluid flow passageways comprise a first fluid flow passageway, a second fluid flow passageway, and a third fluid flow passageway and the outlets comprise a first outlet, a second outlet, and a third outlet, the first fluid flow passageway extending from the fluid intake chamber to the first outlet, the second fluid flow passageway extending from the fluid intake chamber to the second outlet, and the third fluid flow passageway extending from the fluid intake chamber to the third outlet;
wherein the first fluid flow passageway has the intermediate segment having the curve or bend that extends about the pre-selected angle of curvature positioned between the fluid intake chamber and the first outlet, the second fluid flow passageway also has the intermediate segment having the curve or bend that extends about the pre-selected angle of curvature positioned between the fluid intake chamber and the second outlet, and the third fluid flow passageways has the intermediate segment having the curve or bend that extends about the pre-selected angle of curvature positioned between the fluid intake chamber and the third outlet.

14. The nozzle of claim 10, wherein the outlets are circular, slots, round-end slots, arced round-end slots, oval, or generally oval in shape.

15. The nozzle of claim 10, wherein the pre-selected angle of curvature is between 60° and 120°.

16. The nozzle of claim 10, wherein each of the fluid flow passageways has a length, and the intermediate segment that has the curve or bend that extends about the pre-selected angle of curvature is positioned so that an apex of the curve or bend is located at a distance from an interface of the fluid intake chamber that is between 40% and 60% of the length.

17. The nozzle of claim 16, wherein the interface of the fluid intake chamber is an inner portion of the fluid intake chamber at which the fluid flow passageways are fluidly connected to the fluid intake chamber.

18. The nozzle of claim 10, wherein the outlets are positioned so that a center of each outlet is an equidistant distance from centers of the other outlets.

19. The nozzle of claim 10, wherein there are at least three fluid flow passageways and the fluid flow passageways each have a centerline, the centerline of each of the fluid flow passageways being a distance of between 0.635 cm and 1.27 cm from the centerlines of the other fluid flow passageways.

20. A method of making and/or using a nozzle for an earth cutting apparatus, the method comprising:
forming a nozzle via an additive manufacturing process such that the nozzle has a body defining a fluid intake chamber adjacent a first end of the body, a plurality of outlets defined in a second end of the body that is opposite the first end of the body, the outlets including a first outlet and a second outlet, and a plurality of fluid flow passageways, the fluid flow passageways including a first fluid flow passageway extending from the fluid intake chamber to the first outlet and the second fluid flow passageway extending from the fluid intake chamber to the second outlet, the fluid intake chamber having a mouth defined at the first end of the body;
the body being defined such that:
the first fluid flow passageway has an intermediate segment that has a curve or bend that extends about a pre-selected angle of curvature, the intermediate segment of the first fluid flow passageway being located between the fluid intake chamber and the first outlet, and/or
the second fluid flow passageway has an intermediate segment that has a curve or bend that extends about a pre-selected angle of curvature, the intermediate segment of the second fluid flow passageway being located between the fluid intake chamber and the second outlet.
